(19) United States
(12) Patent Application Publication
(10) Pub. No.: US 2016/0169169 A1
(43) Pub. Date: Jun. 16, 2016

(54) TWO WAY VALVE AIR FLOW CONTROL IN FUEL VAPORIZER

(71) Applicant: KEYVAN MEHRABI NEJAD, North York (CA)

(72) Inventor: KEYVAN MEHRABI NEJAD, North York (CA)

(21) Appl. No.: 14/569,854

(22) Filed: Dec. 15, 2014

(51) Int. Cl. F02M 31/18; F02D 41/00; F01M 13/04; F02D 41/26; F02M 25/06; F01M 13/00

(52) U.S. Cl. CPC F02M 31/183; F02M 25/06; F01M 13/0011; F01M 13/04; F02D 41/26; F02D 41/003

(57) ABSTRACT

A fuel vaporizer device to vaporise a fuel comprising of a reservoir having a top enclosure, a bottom enclosure and a height; a blow-by tube adopted to receive blow-by gasses connected to the top enclosure with a first port and a second port; a valve being regulated said blow-by gasses passes through said first port and second port; said first port being connected to an elongated tube sized to reach nearby to said bottom enclosure, said tube having a distal end and a proximal end; a bubbler means to make bubbles being connected at said distal end of said elongated tube inside said fuel; a fuel tube being connected to said top enclosure of said body to transfer said fuel to said body of the fuel vaporizer; and an output port being connected to said top enclosure to transfer a vapor fuel to an engine.

### FIELD OF THE INVENTION

The present invention relates generally to devices for improving the efficiency of gasoline engines.

### BACKGROUND OF THE INVENTION

Modern fuel delivery systems in internal combustion engines attempt to increase efficiency and power of engines. In most gasoline powered engines, the liquid fuel is first vaporized, then mixed with the air inside the engine and then combusted. The fuel vaporization and mixing processes occur at very short times, and therefore, they have to be very efficient, to increase the overall engine efficiency.

Any fuel injection unit that delivers a liquid, or even atomized liquid to the combustion chamber, does not fully vaporize the fuel. The vaporization of the liquid to allow for ignition must take place over a period of several milliseconds. Most engines are not capable to convert all the liquid fuel into vapor for all ranges of engine operations. The liquid fuel that is not converted into vapor may not proper burn and form unburned hydrocarbons and soot which will exit the vehicle exhaust as emission.

Engine manufacturers have been working on developing engines with better fuel efficiency, both by refining fuel injector system and by enhancing the mixing processes in the engine. The multivalve engines are aimed at improving the mixing processes in the engine. The direct injection fuel systems with high injection pressures are aimed at generating very fine fuel drops for faster evaporation. However, will all the improvements; it is difficult to construct an engine that performs efficiently for the wide range of operating systems. The fuel flow rate into the engine may significantly change at different vehicle speeds. Therefore, the time for the evaporation and mixing may change with it. The present invention is aimed at improving the fuel efficiency for a wide range of operating conditions by using a fuel vaporizer upstream of the fuel line.

Fuel vaporizers have been in the market for more than thirty years. They are used to convert liquid gasoline to vapor before it goes into the combustor of the engine.

There are many vaporizer devices introduced in the market and some of them are already in the market. The vaporizer devices have some drawbacks which are not compatible with new engines. They cannot provide a sustainable fuel to the combustion chamber. They cannot smoothly control the amount of vapor going to the engine so sometimes the vapor (fuel+air) is rich of fuel and sometimes it is lean. There is a need to have a new device that solves the previous problems and works well in almost all cars and engines.

### SUMMARY OF THE INVENTION

An air intake system for an engine is an essential system because in the modern internal combustion engine, the intake system must be carefully engineered and tuned to provide the greatest efficiency and power. The present invention is a fuel vaporizer which is added to the air intake system of an engine. Therefore, a mixture of fuel and air, instead of only air, enter the engine. The extra fuel vapor added to the air intake substantially increases the combustion efficiency of the engine, reducing the engine fuel consumption.

The present fuel vaporizer comprises of a canister or a reservoir made of stainless steel, preferably 15 cm in length and about 10 cm wide that is attached to the fuel delivery of either the carburetor or fuel injection system. The Fuel vaporizer works on almost any vehicle using liquid fuel—carburetor, fuel injection, petrol, or turbo diesel. In the fuel injected versions, very limited modification to the fuel delivery system is needed.

One of the objectives of the present invention is to provide a device with substantial savings in the fuel consumption of an engine. Because the present invention divides the blow-by gasses into two ports in the fuel vaporizer, it can help to maintain a constant air/fuel ratio and make vaporized fuel which burn better in the engine.

Another objective of the present invention is to provide a device that decreases pollution and minimize nitric oxide (NOx) production by lowering combustion temperatures.

A fuel vaporizer device to vaporise a fuel comprising of a reservoir having a top enclosure, a bottom enclosure and a height; a blow-by tube adopted to receive blow-by gasses connected to the top enclosure with a first port and a second port; a valve connected between said first port and said second port, wherein said valve regulates the ratio of the blow-by gases going through said first port and said second port; said first port being connected to an elongated tube extended towards said bottom enclosure, said tube having a distal end and a proximal end; a bubbler means to make bubbles being connected at said distal end of said elongated tube inside said fuel; a fuel tube being connected to said top enclosure of said body to transfer said fuel to said reservoir; and an output port being connected to said top enclosure to transfer a vapor fuel to an engine.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a perspective view of the present invention;

FIG. 2 shows a sectional view of the present invention;

FIG. 3 shows a partial sectional view of the present invention; and

FIG. 4 (a-b) shows a schematic diagram of the present invention.

### DETAILED DESCRIPTION OF THE DRAWINGS

A general blow-by system allows combustion blow-by gases to escape from the engine crankcase without getting released into the environment and to return to an intake manifold through a head cover. The blow-by system includes a PCV (Positive Crankcase Ventilation) valve which controls flowing of blow-by gases. The blow-by gasses contain hot air, vaporized fuel, which did not burn, and oil vapor. The present invention uses the blow-by gasses as the air inlet to the fuel vaporizer. A bypass valve is connected to the air inlet section to control the ratio of the fuel to air ratio.

The bypass valve is an essential element of the present device and it is included to control the ratio of the air contacting the fuel in the reservoir. This will maintain the amount of air that goes to the engine at a constant rate. If the bypass valve is closed, all the air entering the vaporizer bubbles through the liquid fuel generating excessive amount of fuel vapor at off design conditions.

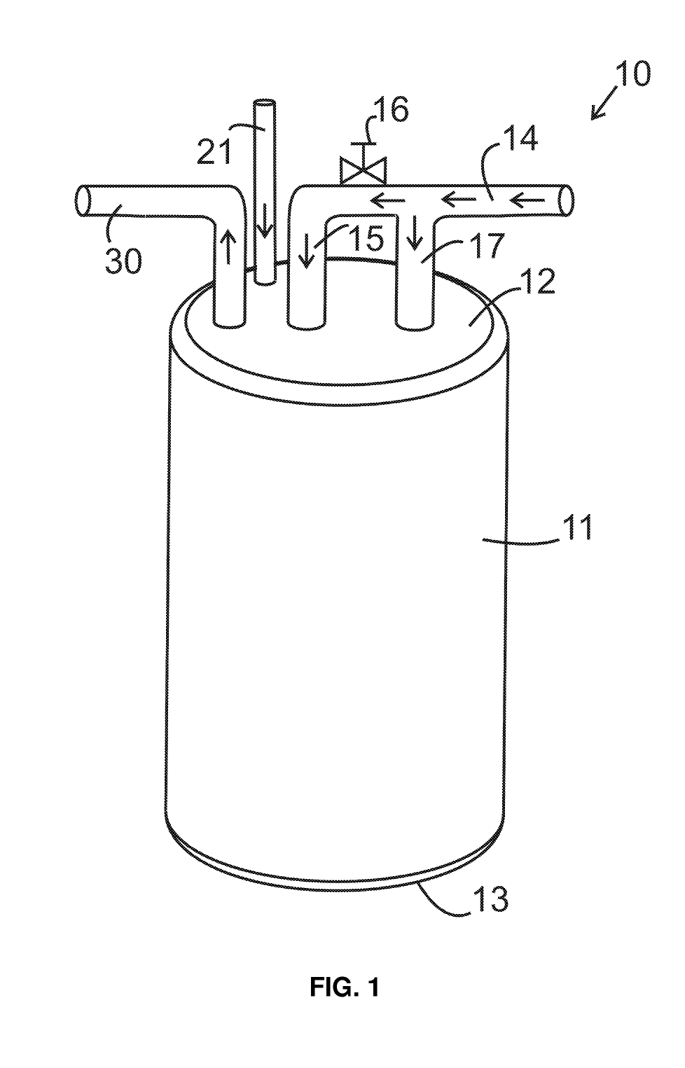

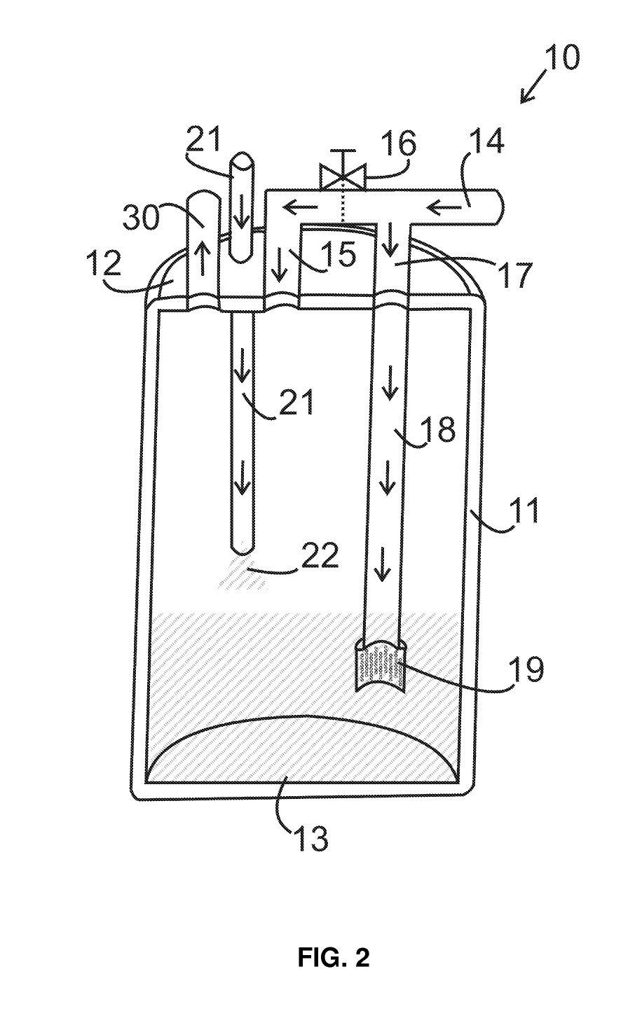

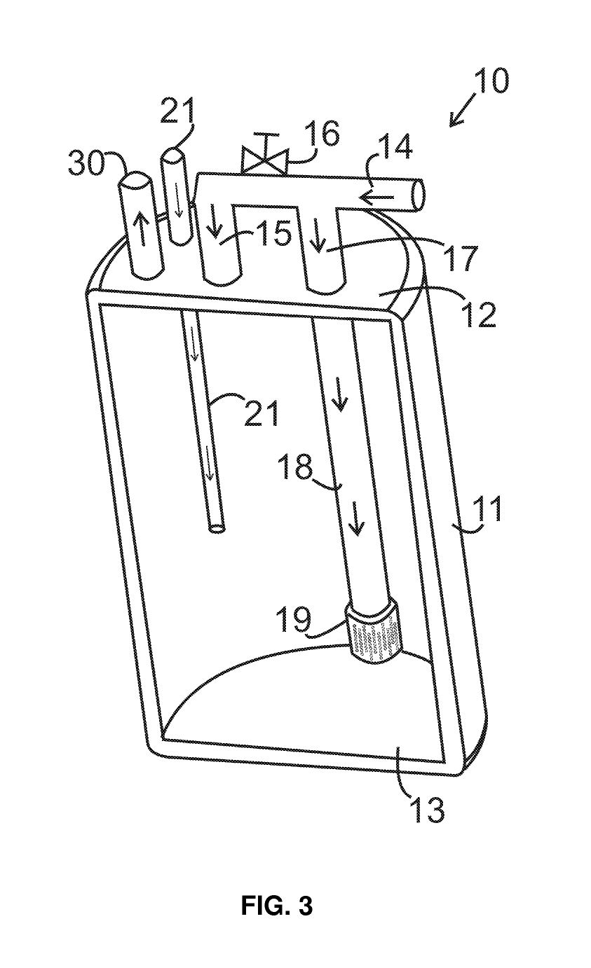

As shown in FIGS. 1-3, the fuel vaporizer 10 comprising of a cylindrical body 11 having a top enclosure 12 and a bottom enclosure 13. A blow-by port 14 adopted to receive blow-by gasses connected to the top enclosure 12 with a first port 17 and have a bypass port 15 and a valve 16. The bypass port 15 is connected to the top enclosure 12. The first port 17 having a tube 18 sized to reach to the bottom enclosure 13 and further having a bubbler means 19 to make bubbles inside a fuel 20.

Again referring to FIGS. 1-3, a fuel 20 is poured into the fuel vaporizer 10 by a fuel port 21 and is connected to the top enclosure 12. The height of the fuel port 21 is preferably half of the height of the fuel vaporizer 10. The smaller height can cause some problems like sending fuel 22 from the bottom of the fuel port 21 directly to an output port 30. This may occur since the pressure inside the cylindrical body 11 is relatively high and it can push the fuel 22 into the outlet line without allowing it to be vaporized. Also with the splash of bubbling fuel, the liquid fuel may enter outlet line and then to the engine without evaporation.

The two inlet lines to the vaporizer control the ratio of the air that goes through the liquid fuel to generate fuel vapor and the air with no fuel vapor. Although the total amount of air is kept the same, the amount of fuel vapor in the air is changed with controlling the valve between the two inlet lines.

Also by using a mesh plate or a perforated plate at the bottom enclosure 13, only the fuel vapor may go through the output port 30. The mesh plate or the perforated plate at the bottom enclosure 13 helps to make more bubbles and enhance vaporizing more liquid fuel. Another way to increase bubbles in the fuel vaporizer is to place a steel wool at the bottom enclosure 13 to change the liquid fuel to the vapor.

The novelty of the present invention is the blow-by port 14 having a first port 17, a bypass port 15 and a valve 16. The bypass port 15 with the help of the valve 16 regulates the ratio of the air contacting the fuel inside the reservoir and also maintains the constant air and fuel ratio.

Without the bypass port 15 and the valve 16, all of the blow-by gasses pass through the liquid fuel. This may result in excessive fuel vapor in the mixture. In this case, the ratio of air and fuel is not constant and it can vary with time. By having the valve 16 in the bypass port 15, the present invention can adjust the amount of air that mixes with the fuel. This allows for the better control of the air/fuel ratio inside the engine at all operating conditions.

The valve 16 can be adjusted by a user or by a computerised sensor which adjust simultaneously the ratio of the blow-by gasses which mix with the fuel and the ratio of the air/fuel. By comparing the efficiency of the engine and the fuel consumption, the ratio of the blow-by gasses are identified.

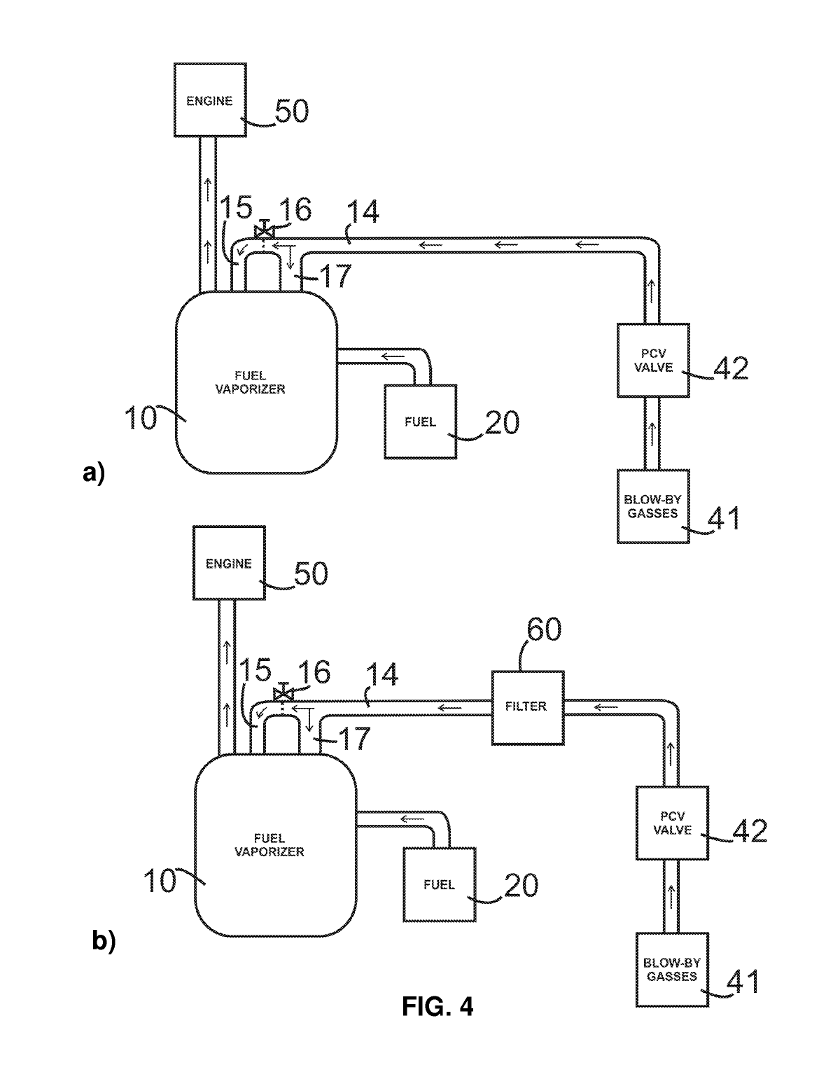

The schematic diagram of the present invention is shown in FIG. 4. The blow-by gasses 41 from a PCV valve 42 go to the fuel vaporizer 10. The blow-by gasses 41 are connected to the gas vaporizer 10 by the first port 17 and have a bypass port 15 and a valve 16 as shown in FIG. 4 (a). After changing the liquid fuel to vapor, the products of the fuel vaporizer go to the engine 50 through the output port 30.

As shown in FIG. 4 (b), because the blow-by gasses 41 have some vapor oil coming from the crankshaft of the engine, another embodiment of the present invention has a filter 60 to remove the oil from the blow-by gasses 41 passed through the PCV valve 42.

The present invention can be made from metallic material or plastic materials that can handle the fuel pressure and temperature. The present invention is preferably made of stainless steel for the best corrosion behaviour but can be made from different materials which act the same.

The valve is designed to adjust the ratio of the blow-by gasses into the fuel vaporizer. It can be any different type of valve, which is operable by a user (a mechanic) or a computer. The user can adjust the valve and set the opening based on the operation efficiency of the engine. The valve which is operated by the computer can learn and adjust the ratio of the blow-by gasses based on the air/fuel ratio which is designed and set in the factory. A computerized valve uses a feed back system from the engine. The feedback system from the engine provides information on the engine fuel efficiency. The valve is adjusted to optimize the engine fuel efficiency.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A fuel vaporizer device to vaporise a fuel comprising of:
a. a reservoir having a top enclosure, a bottom enclosure and a height;
b. a blow-by tube adopted to receive blow-by gasses connected to the top enclosure with a first port and a second port;
c. a valve connected between said first port and said second port, wherein said valve regulates the ratio of the blow-by gases going through said first port and said second port;
d. said first port being connected to an elongated tube extended towards said bottom enclosure, said tube having a distal end and a proximal end;
e. a bubbler means to make bubbles being connected at said distal end of said elongated tube inside said fuel;
f. a fuel tube being connected to said top enclosure of said body to transfer said fuel to said reservoir; and
g. an output port being connected to said top enclosure to transfer a vapor fuel to an engine.

2. The fuel vaporizer device of claim 1, wherein said fuel tube having a height approximately half of said height of said reservoir, whereby any fuel that is injected into the vaporiser lands on the liquid fuel at the bottom of the vaporizer.

3. The fuel vaporizer device of claim 1, wherein said bubbler means being a perforated plate or a mesh plate attached to said distal end of said tube.

4. The fuel vaporizer device of claim 1, wherein said bubbler means being a steel wool placed at said bottom enclosure of said reservoir.

5. The fuel vaporizer device of claim 1, wherein said valve having a regulating means, wherein said regulating means being either manual or automatic.

6. The fuel vaporizer device of claim 5, wherein said automatic means to regulate said valve comprising of a computerized sensor.

7. The fuel vaporizer device of claim 1, wherein said fuel vaporizer further having a filter to remove oil from said blow-by gasses.

8. The fuel vaporizer device of claim 1, wherein said reservoir being made of a metallic material or a plastic material.

9. The fuel vaporizer device of claim 1, wherein said reservoir preferably being made of stainless steel.

10. A fuel vaporizer to be attached to the air intake line of an engine, said vaporizer comprising:
a. a canister to hold a liquid fuel, said canister comprising:
i. a first-gas-inlet line having a distal end, wherein said distal end extending to the bottom of the canister and into the liquid fuel;
ii. a second-gas-inlet line extending only a short distance into the canister and not into the liquid fuel;
iii. a liquid-fuel-inlet line to bring liquid fuel into the canister; and
iv. an air-fuel vapor outlet line to carry a mixture of gases comprising of fuel vapor out of the canister and into the engine;
b. said first-gas-inlet line and said second-gas-inlet line being connected to a blow-by gas line of the engine, whereby blow-by gases from the engine being brought into the canister; and
c. a regulating valve connecting the first-inlet line to the second-inlet line, wherein said regulating valve being used to control the ratio of inlet gases entering the canister through the first and the second gas inlet lines.

11. The fuel vaporizer of claim 10, wherein said regulating valve being a computer controlled valve to optimize the engine fuel efficiency, whereby said valve receives information on the fuel efficiency from the engine and adjusts the flow ratio of the first-inlet line to the second-inlet line to optimize the fuel efficiency.

12. The fuel vaporizer of claim 10, further having a bubbler means connected to the distal end of said first inlet-gas line to enhance the evaporation rate of liquid fuel as the gases pass through the liquid fuel.

13. The fuel vaporizer of claim 10, wherein said canister having a top and a bottom, wherein said inlet lines being connected to the top of the canister.

14. The fuel vaporizer of claim 10, wherein said canister having a length and said liquid fuel inlet line extending half of the length of the canister.
